(19) United States
(12) Patent Application Publication
(10) Pub. No.: US 2009/0119288 A1
(43) Pub. Date: May 7, 2009

(54) APPARATUS AND METHOD FOR SEARCHING MEDIA DATA

(75) Inventors: Kiran Pal SAGOO, Seongnam-si (KR); Il-ku CHANG, Seoul (KR); Young-wan SEO, Yongin-si (KR); Jong-woo JUNG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/265,223

(22) Filed: Nov. 5, 2008

(30) Foreign Application Priority Data
Nov. 5, 2007 (KR) 10-2007-0112105

(51) Int. Cl. G06F 7/06; G06F 17/30

(52) U.S. Cl. 707/5; 707/E17.014

(57) ABSTRACT

An apparatus and method of searching media data is provided. The method of searching media data includes selecting attributes from a displayed category, calculating degrees of correspondence between the selected attributes and media data, and generating specified signals in accordance with the calculated degrees of correspondence.

### CROSS-REFERENCE TO RELATED APPLICATION

This application is based on and claims priority from Korean Patent Application No. 10-2007-0112105 filed on Nov. 5, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to for searching media data, and, more particularly, to an apparatus and method for searching media data that corresponds to attributes selected by a user.

2. Description of the Prior Art

The development of technology has caused the development of portable devices that can collect and store large amounts of media data. As the media data storage space of the portable device is increased, more media data can be stored in the portable device, and this causes a great difficulty in classifying and searching the media data stored in the portable device.

Accordingly, there is a need for an efficient search of multimedia content in a portable media device, and particularly for a prompt and efficient search of media data including pictures.

### SUMMARY OF THE INVENTION

Accordingly, the present invention has been made to solve the above-mentioned problems occurring in the prior art, and an aspect of the present invention is to provide an apparatus and method for searching media data using haptic technology.

Additional aspects and features of the invention will be set forth in part in the description which follows and in part will become apparent to those having ordinary skill in the art upon examination of the following or may be learned from practice of the invention.

In order to accomplish these aspects, there is provided a method of searching media data, according to embodiments of the present invention, which includes selecting attributes from a displayed category; calculating degrees of correspondence between the selected attributes and media data; and generating specified signals in accordance with the calculated degrees of correspondence.

In another aspect of the present invention, there is provided an apparatus for searching media data, which includes a selection module selecting attributes from a displayed category; a calculation module calculating degrees of correspondence between the selected attributes and media data; and a signal-generation module generating specified signals in accordance with the calculated degrees of correspondence.

### BRIEF DESCRIPTION OF THE DRAWINGS

The above and other features and aspects of the present invention will be apparent from the following detailed description taken in conjunction with the accompanying drawings, in which:

FIG. 1 is a block diagram illustrating the construction of an apparatus for searching media data according to an embodiment of the present invention;

FIG. 2 is a flowchart illustrating a method of searching media data according to an embodiment of the present invention;

FIG. 3 is a view illustrating a category, media data, and folders including the media data appearing when a user selects a media type in the method of searching media data as illustrated in FIG. 2;

FIG. 4 is a view illustrating attributes corresponding to a specified category appearing when a user selects the category in the method of searching media data as illustrated in FIG. 2; and

FIG. 5 is a view illustrating a method of creating a container through a user's selection of plural attributes from a category in the method of searching media data as illustrated in FIG. 2.

### DETAILED DESCRIPTION OF THE EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed in the computer or other programmable apparatus to produce a computer implemented process such that the instructions that execute on the computer or other programmable apparatus provide steps for implementing the functions specified in the flowchart block or blocks.

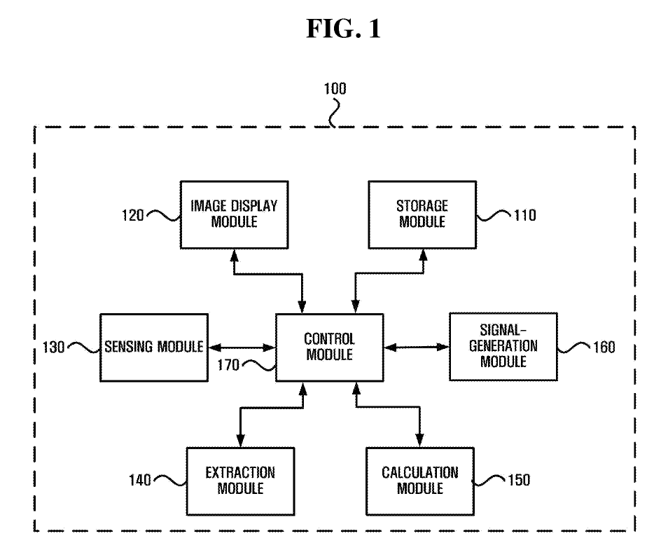

FIG. 1 is a block diagram illustrating the construction of an apparatus for searching media data according to an embodiment of the present invention.

Referring to FIG. 1, the apparatus 100 for searching media data includes a storage module 110, a calculation module 150, a signal-generation module 160, and a control module. The apparatus 100 may further include an image display module 120, a selection module 130, and an extraction module 140.

The storage module 110 stores application software including media data, a media browser application, and others. The media data may include image data and metadata indicating the feature of the image data. The metadata may include a specified attribute, a date, a user name, and so forth, in a category of an image such as a color, a shape, a facial expression, a face, and so forth, and a user can search the media data using the metadata. Also, the metadata includes a directory listing users' addresses and phone numbers, and in the directory, image data indicating the features of the respective users may be included. Here, the image data may include a photograph of the user's face.

In an embodiment of the present invention, a color category may include attributes of red, green, and blue colors, and a shape category may include attributes of a square, a rectangle, a circle, and so forth. A facial expression category may include attributes of a happy expression, a sad expression, an absence of expression, and so forth, and a face category may include attributes of images stored in the directory, and so forth.

Specifically, according to the color category, an RGB channel may be used in expressing the color of image data, and the RGB channel uses red, green, and blue colors in expressing the color. Also, by mixing the red, green, and blue colors, all colors stored in the image data can be expressed.

Accordingly, if specified values are set for red, green, and blue colors, all colors of the image data can be expressed as values that correspond to the specified values, and these values are stored as the metadata. As described above, the media data includes the metadata and the image data. Colors can be represented by another color model in addition to the RGB color model, and as described above, specified values are allocated to the respective colors in the above-described color model to be stored as metadata.

Specifically, according to the shape category, the shape of image data is represented using a geometrical shape. The geometrical shape may include a circle, a rectangle, a triangle, and so forth. By setting specified values for the respective geometrical shapes, the shape of the image data can be represented as a combination of the respective shapes, and the combined shape has correspondence values corresponding to the respective specified values. The correspondence values are stored as the metadata.

According to the facial expression category, a happy expression, a sad expression, and an absence of expression are set as the standard expressions, and by combining the standard expressions, the expression of a human face in the image data can be represented. Accordingly, if the specified values are set for the happy expression, the sad expression, and the absence of expression, respectively, and the set specified values are combined, the feature of the image data can be expressed as the metadata, and the combined shape has the correspondence values that correspond to the respective specified values. These correspondence values are stored as the metadata.

According to the face category, attributes of image data (including a user's face image) stored in a directory of the media data are stored as metadata.

The method of storing the above-described attributes as metadata is merely exemplary, and is not limited thereto.

The image display module 120 displays a specified image to a user. If the user selects a specified image being displayed, the image display module 120 displays the corresponding image. For example, if the user selects a specified image or drags a specified region of the image through a touch screen, the selection module 130 can sense the corresponding operation. The sensed signals are transferred to the control module 170, and the control module calls the data from the storage module 110 and displays the image selected by the user through the image display module 120.

Specifically, if the user selects a search window being displayed on the image display module 120, the selection module 130 senses the operation selected by the user, generates and transfers signals that correspond to the selected operation to the control module 170. If the signal is transferred to the control module 170, the control module 170 calls data from the storage module 110, and displays the searched image such as a picture, music, video, and so forth, through the image display module 120.

If the user selects an icon of a picture after the picture is displayed, icons of a color, a shape, a facial expression, a face, and so forth, that correspond to the category of the picture, are displayed in the same manner as described above. If the user selects any one of the icons in the attributes, the corresponding image is displayed. This displayed image may correspond to at least one folder including media data and so on and at least one set of media data. If the user's finger approaches the displayed folder or media data, metadata is extracted from all the media data in the folder through the extraction module 140, which will be described later, in order to calculate the degrees of correspondence between the attributes and the media data. If the metadata is extracted, as described above, the specified values stored in the metadata are calculated, and signals that correspond to the calculated values are generated to provide a specified reaction to the user. The specified reaction may include at least one of vibration and sound, but is not limited thereto. In addition, the strength of the specified reaction may differ depending upon the signals that correspond to the calculated values, the details of which will be described later. The above-described process may be performed whenever the user moves his/her finger to approach the folder and the media data. Thereafter, if the user selects a folder having the strongest reaction, the image display module 120 displays the media data in the folder, and the user can search the desired media data by confirming the media data.

In an embodiment of the present invention, if a plurality of sets of media data in the folder is displayed, as described above, the user can set a region of the media data that is displayed on the image display module 120. If the user's finger approaches the set region, a specified reaction occurs, and thus the user can search the desired media data.

In an embodiment of the present invention, if the user sees the image being displayed through the image display module 120 and selects a specified icon or a plurality of icons, the selection module 130 can sense the icon(s) selected by the user. After the user senses the selected icon(s), the selection module 130 generates signals for reporting the above-described operation, and transfers the generated signals to the control module 170. The selection module 130 senses all the operations occurring between the image display module 120 and the user, generates and transfers the specified signals that correspond to the sensed operation to the control module 170.

If the user approaches his/her finger to a screen on which a specified folder or a plurality of media data are displayed after the user selects specified attributes, the extraction module 140 extracts the metadata that corresponds to the attributes selected from all media data in the specified folder or all the selected media data. The extracted metadata is transferred to the control module 170, and then is transferred to the calculation module 150 in accordance with a command from the control module 170. For example, the extracted metadata is stored in the storage module 110, and then is transferred to the calculation module 150 according to the command of the control module 170.

If the metadata is extracted from the extraction module 140, the calculation module 150, as described above, calculates the degrees of correspondence between the attributes set by the user and the media data using the metadata extracted from the selected folder(s) or the plurality of media data selected. Using the calculated degrees of correspondence, the degrees of correlation between the attributes selected by the user and the selected folder(s) or the plurality of media data selected are calculated.

If the degrees of correlation are calculated, the corresponding calculated values are transferred to the control module 170, and then are transferred to the signal-generation module 160 in accordance with the command of the control module 170. For example, the calculated values are stored in the storage module 110, and then transferred to the signal-generation module according to the command of the control module 170.

The signal-generation module 160, which has received the calculated values from the calculation module 150 or the storage module, generates specified signals that correspond to the calculated values. The specified signal may include vibration or sound.

In an embodiment of the present invention, the specified signals may be divided into 5 grades, and different signals may be generated through the adjustment of the signal strength by grades. The generated signal may be a vibration signal generated using a vibration device (not illustrated) or sound generated using a speaker (not illustrated). In accordance with the degrees of correlation with the selected attributes, different sound or different vibration may be generated. Also, the signal levels may be diversely changed according to the user setting.

The control module 170 serves to manage and control all the constituent elements in the search apparatus, such as the storage module 110, the image display module 120, the selection module 130, the extraction module 140, the calculation module 150, and the signal-generation module 160.

In contrast, the apparatus 100 for searching media data according to the present invention may be built in a cellular phone, a PDA, and so forth.

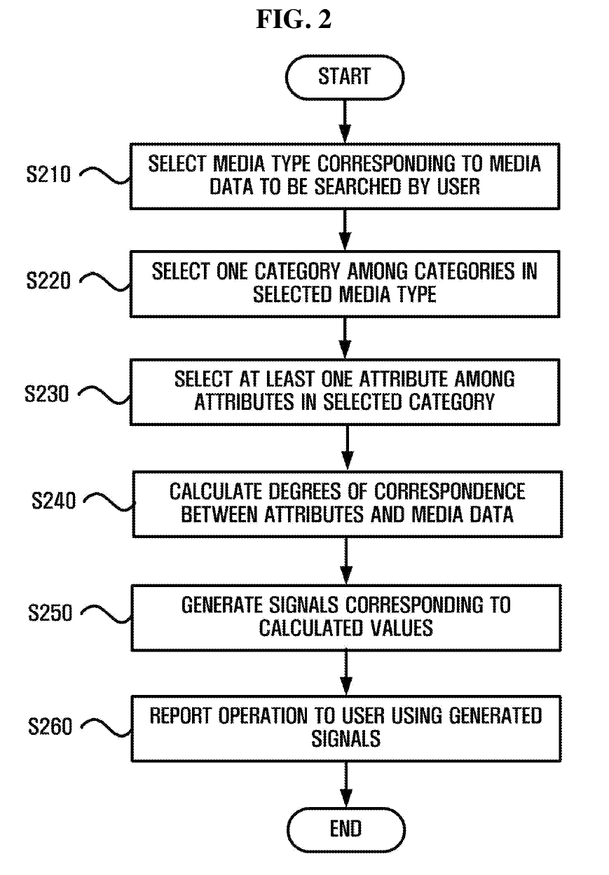

FIG. 2 is a flowchart illustrating a method of searching media data according to an embodiment of the present invention.

Referring to FIG. 2, a user selects the type of media data that corresponds to the media data to be searched S210.

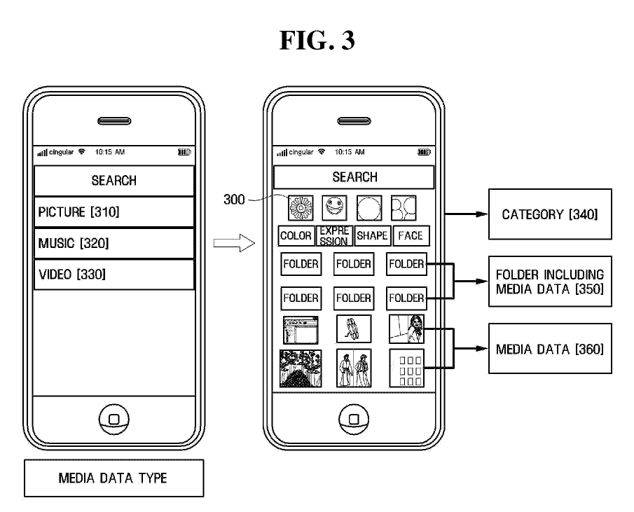

FIG. 3 is a view illustrating a category, media data, and folders including the media data appearing when a user selects the media type in the method of searching media data as illustrated in FIG. 2.

The media data type may include a picture 310, music 320, and a video 330. If the user selects the picture 310, diverse categories 340 are displayed through the image display module 120. The categories 340 displayed through the image display module 120 may include a color 300, a shape, a facial expression, and a face. Also, the image being displayed through the image display module 120 may further include at least one of media data and folders including media data. The above-described categories 340 may be changed, e.g., may be added or reduced, in accordance with the user setting. If the user selects music 320 or video 330, the music 320 or video 330 can be searched according to the conventional searching method.

Referring to FIG. 2, after selecting the type of media data, the user selects one category among the categories 340 in the selected media type S22.

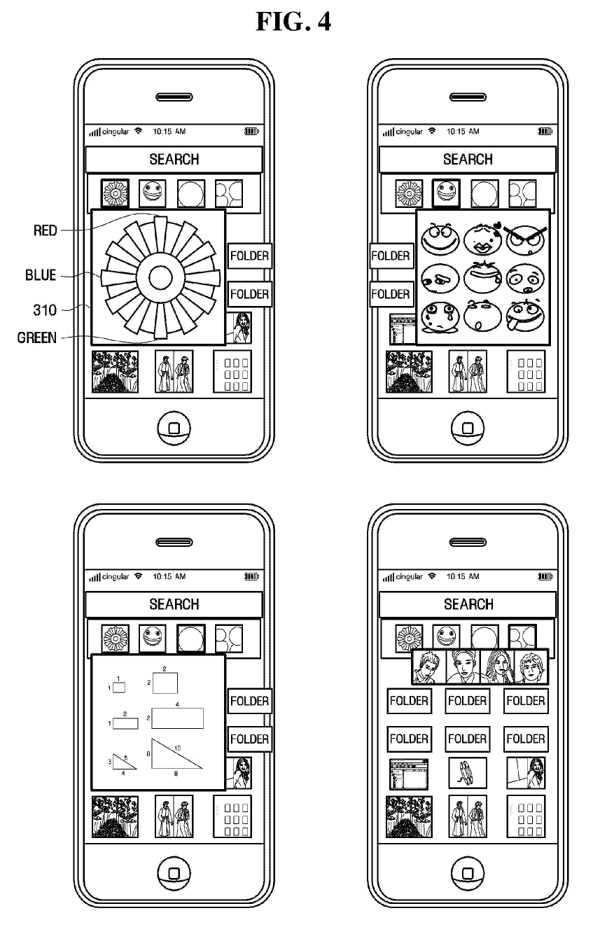

FIG. 4 is a view illustrating attributes corresponding to a specified category appearing when a user selects the category in the method of searching media data as illustrated in FIG. 2.

Referring to FIG. 4, if the user selects a color category among the categories 340 being displayed through the image display module 120, corresponding attributes of red, green, and blue are displayed on the screen. Furthermore, the attributes may further include additional colors that are between two of the red, green and blue colors in a color wheel 310. If the user selects a facial expression category, corresponding attributes composed of icons that represent a happy expression, a sad expression, an absence of expression, and so forth, are displayed. If the user selects a shape category, corresponding attributes having shapes of a square, a rectangle, a circle, and so forth, are displayed in the form of icons. If the user selects a face category, image data of people corresponding to addresses stored in the directory of the storage module is displayed.

Referring to FIG. 2, at least one attribute among the attributes in the selected category 340 is selected S230. For example, if the user selects one attribute among the attributes being displayed through the image display module 120 (e.g., in the case of the color category, the attributes of red, green, and blue, or any other color therein between; in the case of the shape category, attributes in the shape of a square, a rectangle, a circle, and so forth; in the case of the facial expression category, attributes of a happy expression, a sad expression, an absence of expression, and so forth; and in the case of the face category, attributes of images stored in the directory of the storage module), the media data stored in the storage module 110 may be displayed through the image display module 120. In addition, the media data may be included in one or more folders, and thus the media data and the folders including the media data may be displayed on the screen through the image display module 120.

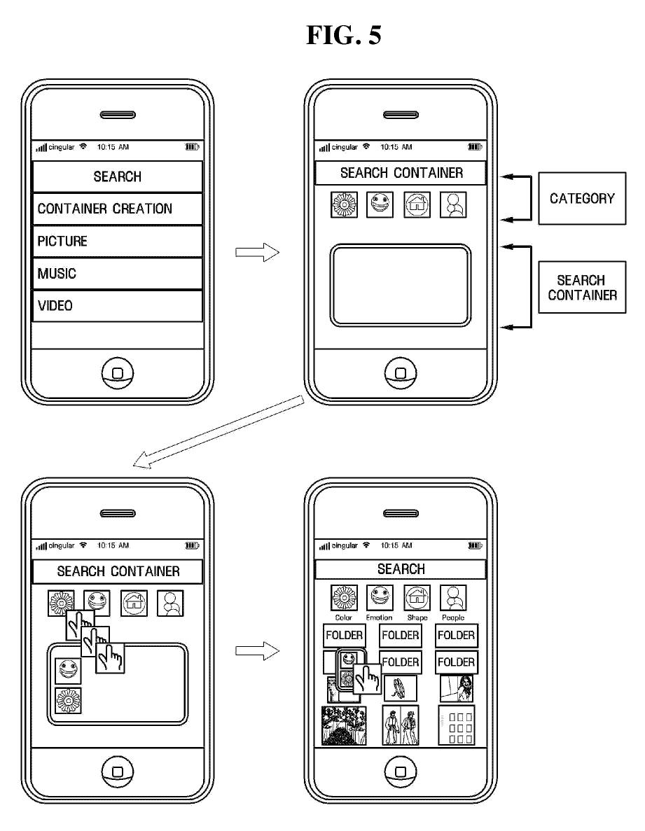

FIG. 5 is a view illustrating a method of creating a container through a user's selection of plural attributes from a category in the method of searching media data as illustrated in FIG. 2.

Referring to FIG. 5, the user may select two or more attributes among the attributes being displayed through the image display module 120. For example, the user may select two or more attributes in the same category, or may select two or more attributes in different categories. If the user selects two or more categories, a container that includes two or more attributes is generated.

Referring to FIG. 2, if at least one of a folder and media data is displayed through the image display unit 120, the degrees of correspondence between the attributes and the media data are calculated S240.

For example, if the user selects the attributes, the degrees of correspondence between the selected attributes and the folder including all the media data or all the media data stored in the media data searching apparatus 100 is calculated. The calculated degrees of correspondence are transferred to the media search apparatus 100, and a following process S250 will be described later.

For example, if the user approaches his/her finger to a specified folder, the degrees of correspondence between all the media data in the folder and the attributes selected by the user is calculated through the media data search apparatus 100. As described above, the respective media data includes values that correspond to the attributes selected by the user as the metadata, and the metadata is extracted from the media data. Using the extracted metadata, the degrees of correspondence between the media data and the attributes selected by the user are calculated, and the calculated values are transferred to the media search apparatus 100. A following process S250 will be described later. In addition, if the user's finger approaches another folder, the above-described processes are repeated to calculate the degrees of correspondence between all the media data in the folder and the attributes.

For example, the user may select a plurality of folders using his/her finger. If the user selects the plurality of folders, the metadata is extracted from all the media data in the plurality of folders, and the degrees of correspondence between the extracted metadata and the attributes are calculated, in the same manner as described above. Thereafter, the user repeats the above-described processes.

For example, the user may select a plurality of media data using his/her finger. If the user selects the plurality of media data, the degrees of correspondence between the media data and the attributes are calculated.

Referring to FIG. 2, if the degrees of correspondence between all the media data in the folder and the attributes are calculated, signals that correspond to the calculated values are generated S250.

For example, in the case where the user selects the attributes, and the degrees of correspondence between all the media data stored in the media data search apparatus 100 and the selected attributes are simultaneously calculated, the media data search apparatus 100 divides the degree of correspondence between the attributes and the folder or the selected media data into grades and generates different signals. The degree of correspondence may be divided into five grades, and may be changed according to the user setting. The signals are changed by grades, and as the degree of correspondence becomes greater, a stronger signal is generated. Alternatively, the signal may be generated only in the case where the degree of correspondence is the highest.

For example, in the case where the user selects the attributes, and then approaches the folder or the plurality of media data with his/her finger to calculate the degrees of correspondence, the degrees of correspondence between the selected attributes and all the media data stored in the selected folder or all the selected media data are calculated as values, and different signals are generated in accordance with the degrees of correspondence represented by numerals. Using these different signals, a strong signal, which corresponds to the highest degree of correspondence, is generated through a vibrator or a speaker.

As described above, if a signal that corresponds to the degree of correspondence between the attribute value and the media data is generated, this operation is reported to the user using the generated signal S260. That is, using the generated signal, the degree of correspondence between the attribute and the folder or the media data is reported to the user through the vibrator or the speaker. Here, the vibrator produces vibration and the speaker produces sound to report the degree of correspondence to the user.

As described above, according to the apparatus and method of searching media data according to embodiments of the present invention, media data stored in the folder can be searched even without opening the folder, and thus the time required for the media data search can be reduced.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of searching for media data, comprising:
selecting attributes from a displayed category;
calculating degrees of correspondence between the selected attributes and media data; and
generating signals in accordance with the calculated degrees of correspondence.

2. The method of claim 1, further comprising:
if the type of the media data to be searched for is selected by a user before the selecting, displaying at least one of categories of the selected type, the media data, and folders including the media data; and
if the at least one of the categories being displayed is selected, displaying the attributes of the selected category.

3. The method of claim 1, wherein the category includes at least one of a color category, a facial expression category, a shape category, and a face category; and
wherein the color category includes at least one of attributes of red, green, and blue; the facial expression category includes at least one of attributes of a happy expression, a sad expression, and an absence of expression; the shape category includes at least one of attributes of a square, a rectangle, and a circle; and the face category includes attributes of image data stored in a directory.

4. The method of claim 1, wherein the media data comprise image data and metadata; and the metadata comprise values corresponding to the attributes.

5. The method of claim 1, wherein the calculating comprises calculating the degrees of correspondence between the selected attributes and the media data, wherein the media data are selected from displayed media data.

6. The method of claim 1, wherein the calculating comprises calculating the degrees of correspondence between the selected attributes and the media data, wherein the media data are in selected ones of displayed folders.

7. The method of claim 1, wherein the calculating comprises calculating the degrees of correspondence between the selected attributes and the media data, wherein the media data are in a plurality of folders selected from displayed folders.

8. The method of claim 1, wherein the generated signals comprise at least one of vibration and sound; and
wherein the method further comprises informing a user of the degrees of correspondence between the selected attributes and the media data using the generated signals.

9. The method of claim 1, wherein the selecting comprises creating a container that includes the selected attributes;
wherein the calculating comprises calculating the degrees of correspondence between the selected attributes included in the container and the media data,
wherein the media data are selected from the displayed media data.

10. The method of claim 1, wherein the calculating comprises extracting metadata from the media data.

11. The method of claim 1, wherein the calculating comprises calculating the degrees of correspondence between the selected attributes and the media data, the media data being selected from displayed media data; and
wherein the generating comprises generating signals in accordance with the degrees of correspondence between the selected attributes and the media data selected from the displayed media data.

12. An apparatus for searching for media data, comprising:
a selection module which selects attributes from a displayed category;
a calculation module which calculates degrees of correspondence between the selected attributes and media data; and
a signal generation module which generates signals in accordance with the calculated degrees of correspondence.

13. The apparatus of claim 12, wherein the category includes at least one of a color category, a facial expression category, a shape category, and a face category; and
wherein the color category includes at least one of attributes of red, green, and blue; the facial expression category includes at least one of attributes of a happy expression, a sad expression, and an absence of expression; the shape category includes at least one of attributes of a square, a rectangle, and a circle; and the face category includes attributes of image data stored in a directory.

14. The apparatus of claim 12, wherein the media data comprise image data and metadata; and the metadata comprise values corresponding to the attributes.

15. The apparatus of claim 12, wherein the calculation module calculates the degrees of correspondence between the selected attributes and the media data, wherein the media data are selected from displayed media data.

16. The apparatus of claim 12, wherein the calculation module calculates the degrees of correspondence between the selected attributes and the media data, wherein the media data are in selected ones of displayed folders.

17. The apparatus of claim 12, wherein the calculation module calculates the degrees of correspondence between the selected attributes and the media data, wherein the media data are in a plurality of folders selected from displayed folders.

18. The apparatus of claim 12, wherein the generated signals comprise at least one of vibration and sound; and
wherein the degrees of correspondence between the selected attributes and the media data are reported to a user using the generated signals.

19. The apparatus of claim 12, wherein the calculation module comprises an extraction module that extracts the metadata from the selected media data, and calculates the degrees of correspondence between the selected attributes and the media data using the metadata extracted by the extraction module.

20. The apparatus of claim 12, wherein the calculation module calculates the degrees of correspondence between the selected attributes and the media data, the media data being selected from displayed media data; and
wherein the signal-generation module generates signals in accordance with the degrees of correspondence between the selected attributes and the media data selected from the displayed media data.
